(19) United States
(12) Patent Application Publication
(10) Pub. No.: US 2012/0075690 A1
(43) Pub. Date: Mar. 29, 2012

(54) WAVELENGTH CONVERSION ELEMENT AND APPARATUS FOR GENERATING SHORT WAVELENGTH LIGHT USING SAME

(75) Inventors: Kiminori Mizuuchi, Ehime (JP); Akifumi Aono, Ehime (JP)

(73) Assignee: PANASONIC CORPORATION, Kadoma-shi, Osaka (JP)

(21) Appl. No.: 13/322,825

(22) PCT Filed: Jun. 9, 2010
(86) PCT No.: PCT/JP2010/003827

§ 371 Date: Nov. 28, 2011

(30) Foreign Application Priority Data
Jun. 16, 2009 (JP) 2009-142827

(51) Int. Cl. G02F 1/35; G02F 1/355

(52) U.S. Cl. 359/328

(57) ABSTRACT

A wavelength conversion element (1) for converting fundamental waves (2) into harmonic waves (3) having wavelengths shorter than those of the fundamental waves (2), the wavelength conversion element (1) includes a low refractive index region (4) having a refractive index lower than those of the other regions. The low refractive index region (4) is formed in the forming region of a thermal lens and is desirably formed between the light outputting side and the light collecting position of the fundamental waves (2). The wavelength conversion element (1) of the present invention includes the low refractive index region (4) that reduces a refractive power generated by the thermal lens, thereby achieving a stable output even with a high output. An apparatus for generating short wavelength light by using the wavelength conversion element (1) includes a fundamental wave light source and a light collecting optical system (5) that collects the fundamental waves.

### TECHNICAL FIELD

The present invention relates to a wavelength conversion element and an apparatus for generating short-wavelength light using the same, and particularly relates to a wavelength conversion element that generates a harmonic beam by using a nonlinear optical effect and an apparatus for generating short-wavelength light using the same.

### BACKGROUND ART

In a known wavelength conversion device for generating light with a shorter wavelength than light from a light source, a fundamental-wave laser beam is generated from a fundamental-wave laser beam light source, the fundamental-wave laser beam is collected on a wavelength conversion element by a light collecting element, and then the wavelength of the fundamental-wave laser beam is converted by the nonlinear effect of the wavelength conversion element. In another known wavelength conversion device, the beam positions of fundamental waves are moved in a nonlinear optical crystal to reduce a power density, so that a stable output is obtained (Patent Literature 1).

### CITATION LIST

### Patent Literature

Patent Literature 1: Japanese Patent Laid-Open No. 2007-72134

### SUMMARY OF INVENTION

### Technical Problem

In a wavelength conversion element and an apparatus for generating short-wavelength light using the same according to a known technique, unfortunately, a high output becomes unstable and the conversion efficiency fluctuates. In order to solve the problem, in the technique of Patent Literature 1, the beam positions of fundamental waves are changed so as to reduce an average power density. In this configuration, however, the beam position of harmonic wave output simultaneously varies with the change of the beam position of the fundamental waves, leading to a reduction in the beam quality of harmonic waves. Thus, unfortunately in the known technique, the light collecting characteristics of harmonic wave output deteriorate and a power density considerably decreases on a light collecting point.

An object of the present invention is to provide a wavelength conversion element that can stably generate short wavelength light even at a high output, and an apparatus for generating short-wavelength light using the same.

### SOLUTION TO PROBLEM

In order to solve the foregoing problem, a wavelength conversion element of the present invention includes a low refractive index region having a lower refractive index than those of other regions, in order to convert fundamental waves into harmonic waves having shorter wavelengths than those of the fundamental waves.

The apparatus for generating short-wavelength light according to the present invention collects fundamental waves in the wavelength conversion element and converts the fundamental waves into harmonic waves having shorter wavelengths in the wavelength conversion element, wherein the low refractive index region is formed in a region allowing passage of a fundamental wave beam in the wavelength conversion element.

### ADVANTAGEOUS EFFECTS OF INVENTION

A wavelength conversion element according to the present invention includes a low refractive index region in the propagation region of a fundamental wave beam. Hence, a wavelength conversion element and an apparatus for generating short-wavelength light using the same according to the present invention can generate stable short-wavelength light by suppressing the occurrence of a thermal lens that is disadvantageous in the generation of high-output harmonic waves.

### BRIEF DESCRIPTION OF DRAWINGS

FIG. 1 is a structural diagram illustrating an apparatus for generating short-wavelength light according to the present invention.

FIG. 2 illustrates a state where a thermal lens is formed in a wavelength conversion element of the apparatus for generating short-wavelength light.

FIG. 3 illustrates an unstable output phenomenon in the wavelength conversion element.

FIG. 4 illustrates the relationship between a refractive index difference between a low refractive index region of the wavelength conversion element and the other regions and the conversion efficiency of the wavelength conversion element.

FIG. 5 defines a beam waist on the light collecting point of the wavelength conversion element.

FIG. 6 illustrates the relationship between a distance from the light collecting point and a beam diameter in the wavelength conversion element.

FIG. 7 illustrates the location of the low refractive index region of the present invention.

FIG. 8 shows calculation results on the relationship between a distance between a light collecting point and an entrance end face on the horizontal axis and a distance between the light collecting point and the center position of the thermal lens in the wavelength conversion element on the vertical axis.

FIG. 9A is an explanatory drawing illustrating the initial process of a method of manufacturing the wavelength conversion element.

FIG. 9B is an explanatory drawing illustrating the intermediate process of the method of manufacturing the wavelength conversion element.

FIG. 9C is an explanatory drawing illustrating the terminal process of the method of manufacturing the wavelength conversion element.

FIG. 10 illustrates an example of the characteristics of the wavelength conversion element according to the present invention.

FIG. 11A illustrates an outgoing beam from the wavelength conversion element having no low refractive index region formed.

FIG. 11B illustrates an outgoing beam from the wavelength conversion element including the low refractive index region.

FIG. 12 illustrates a technique of confirming the formation of the low refractive index region by an internal observation from an end face of the wavelength conversion element.

FIG. 13 illustrates another example of the method of manufacturing the wavelength conversion element.

### DESCRIPTION OF EMBODIMENTS

### [Instability of Wavelength Conversion Element]

A wavelength conversion element using a nonlinear optical effect can convert fundamental waves of an infrared region into harmonic waves from an ultraviolet to visible region. The nonlinear optical effect is proportional to the power density of fundamental waves, so that efficiently generated harmonic waves require fundamental waves with a high power density. An increase in power density may, however, enhance other nonlinear effects that interfere with the stability of output. According to the present invention, the instability of output can be suppressed in a high power region.

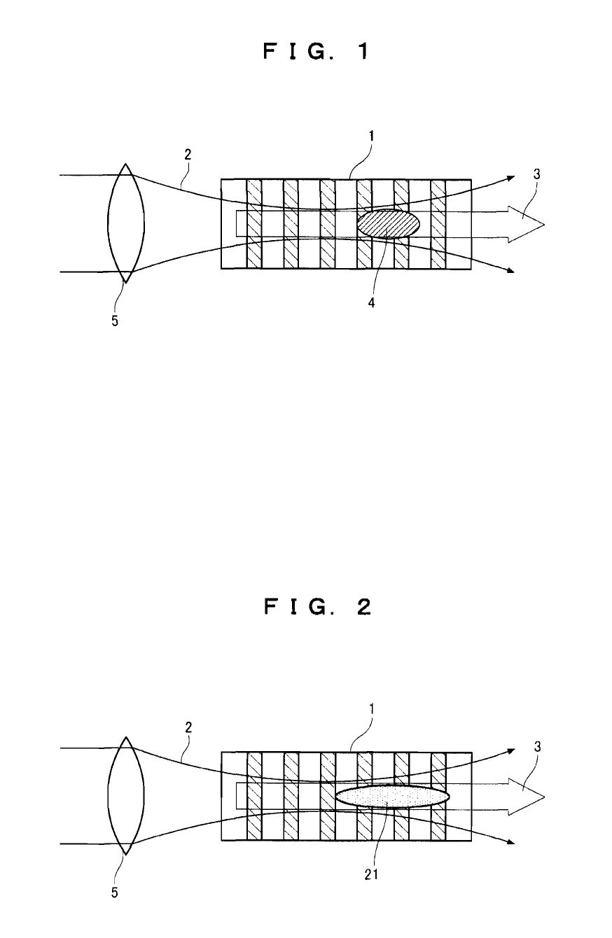

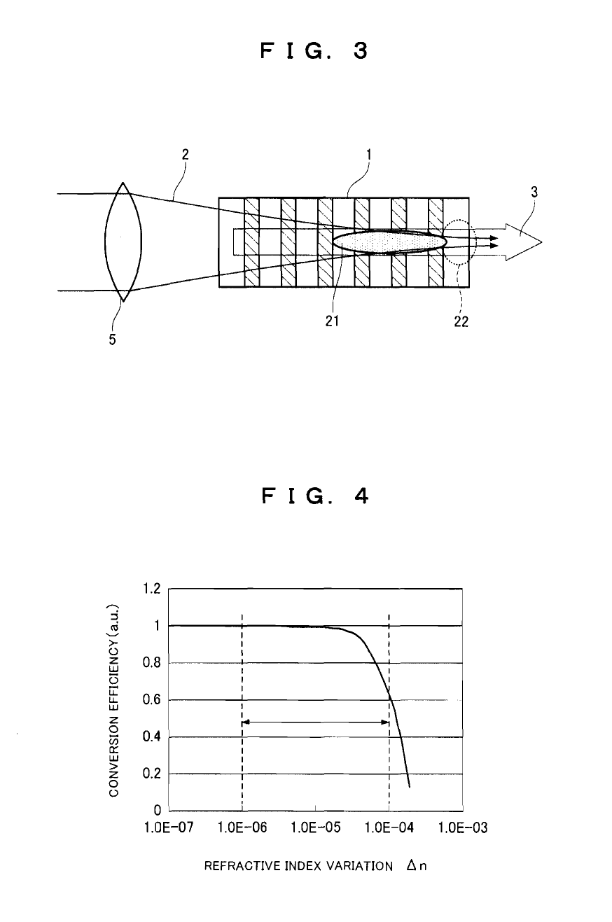

The present inventors have determined the cause of disadvantageous instability of output. Referring to FIGS. 2 and 3, the output instability will be discussed below. As shown in FIG. 2, fundamental waves 2 are collected into a wavelength conversion element 1 by a light collecting optical system 5 and then are emitted from the wavelength conversion element 1 in a diverging manner. The collected fundamental waves 2 are converted into harmonic waves 3 by the nonlinear optical effect of the wavelength conversion element 1. The generation of second harmonic waves by a secondary nonlinear optical effect will be described below. For example, infrared light having a wavelength of 1064 nm is used as the fundamental waves 2 and the harmonic waves 3 are generated with a wavelength of 532 nm by means of the wavelength conversion element 1 acting as an SHG element.

For the substrate of the wavelength conversion element 1, LiNbO₃ doped with Mg with a periodic polarization inversion structure was used. In the case where the harmonic waves 3 of nearly 2.5 W were generated from the fundamental waves 2 of about 8 W in wavelength conversion, the outputted fundamental waves 2 and harmonic waves 3 varied in beam shape, resulting in unstable conversion efficiency.

In the evaluation of the characteristics of the wavelength conversion element 1, it was observed that the temperature of the wavelength conversion element 1 increases and the beam divergence angle of the outgoing harmonic waves 3 decreases with an increase in the power of the harmonic waves 3. This is because a propagating beam is collected by a thermal lens effect so as to reduce the divergence angle of the harmonic waves 3 serving as an outgoing beam. Particularly, it was observed that the output beam of the harmonic waves 3 near unstable output is collected around an output end face in the wavelength conversion element 1.

As shown in FIG. 2, a thermal lens 21 is caused by the mixed fundamental waves 2 and harmonic waves 3 in the same beam in the wavelength conversion element 1. Crystals constituting the wavelength conversion element 1 absorb the fundamental waves 2 by visible light irradiation and then nonlinearly absorb visible light. Thus, the higher the power density of the harmonic waves 3, the larger the coefficient of absorption. In the case where a temperature is partially raised by absorption, the thermal lens 21 is generated as shown in FIG. 2. The thermal lens 21 has a convex lens effect that collects propagating light. As the lens power of the thermal lens 21 increases, a propagating beam changes from a diverging state to a collimating state and a light collecting state. The absorption ratio of nonlinear absorption increases with increase in the power density of the harmonic waves 3, which further increases the lens power. As the lens power of the thermal lens 21 increases, the propagating fundamental waves 2 and harmonic waves 3 are collected as shown in FIG. 3, so that the power density increases near the exit end face of the wavelength conversion element 1 and increased absorption accelerates the absorption of light. In response to a temperature increase caused by heat generated in light absorption, a temperature distribution is generated in the wavelength conversion element 1 and the phase matching conditions of the wavelength conversion element 1 are changed, leading to lower conversion efficiency. By repeating this operation, the output considerably fluctuates. Specifically, as shown in FIG. 3, an unstable region 22 is formed near the exit end face of the wavelength conversion element 1 by light absorption, so that the harmonic waves are unstably outputted. In other words, in the state of FIG. 2, the diameter of a divergent beam decreases so as to increase the power density of the fundamental waves 2, leading to higher conversion efficiency, whereas in the state of FIG. 3 illustrating the unstable region 22, the output considerably fluctuates due to increased absorption.

In this explanation, LiNbO₃ crystals doped with Mg were described. The same phenomenon occurs in other nonlinear optical crystals such as LiNbO₃, LiTaO₃, KTP, LiNbO₃ and LiTaO₃ crystals doped with, e.g., Zn, In and Sc, and LiTaO₃ crystals doped with Mg.

### [A Wavelength Conversion Element and an Apparatus Using the Same According to the Present Invention]

A wavelength conversion element according to the present invention reduces the instability of high output characteristics appearing through a thermal lens. The wavelength conversion element will be specifically described below.

### EMBODIMENT

FIG. 1 is a structural diagram illustrating a wavelength conversion element 1 and an apparatus using the same according to an embodiment of the present invention. In the apparatus of FIG. 1, fundamental waves 2 are collected into the wavelength conversion element 1 by a light collecting optical system 5 and then are wavelength-converted into harmonic waves 3. Moreover, a low refractive index region 4 is formed in the beam penetration region of the fundamental waves 2 in the wavelength conversion element 1. The low refractive index region 4 is a region having a lower refractive index than those of the other regions.

The following will describe the characteristics of the wavelength conversion element 1 including the low refractive index region 4 according to the present invention. The present inventors evaluated the high output characteristics of the wavelength conversion element 1 of the present invention illustrated in FIG. 1 and the high output characteristics of the known wavelength conversion element 1 illustrated in FIGS. 2 and 3. Specifically, the stability of output was evaluated by conducting an experiment in which the fundamental waves 2 having a wavelength of 1064 nm were emitted to generate the harmonic waves 3 having a wavelength of 532 nm. As a result, in the known wavelength conversion element 1 not including the low refractive index region, the output of the harmonic waves 3 became unstable around 2.5 W, whereas in the wavelength conversion element 1 including the low refractive index region 4 according to the present invention, a stable output was obtained around up to 3 W, so that the high output characteristics were improved by 1.2 times as compared with the known wavelength conversion element 1.

This is because the low refractive index region 4 of FIG. 1 has a concave lens effect. To be specific, the thermal lens 21 generated by absorption shown in FIGS. 2 and 3 is a convex lens having a high refractive index, so that the wavelength conversion element 1 collects a propagating beam and increases absorption nonlinearly, leading to the formation of the unstable region 22 around a light collecting point. In contrast to the known wavelength conversion element 1, the low refractive index region 4 of FIG. 1 has the concave lens effect that can offset :he thermal lens effect. Thus, the occurrence of the unstable region 22 can be suppressed.

It should be noted that the refractive index distribution of the low refractive index region 4 can suppress the collection of the generated harmonic waves 3 through the thermal lens 21. As has been discussed, the thermal lens 21 is formed in a region where the beams of the fundamental waves 2 and the harmonic waves 3 overlap each other. In the case where the fundamental waves 2 are converted into the harmonic waves 3 by the wavelength conversion element 1 having the periodic polarization inversion structure, a beam is incident substantially in the same direction as the direction of the periodic structure, so that the beams of the fundamental waves 2 and the harmonic waves 3 propagate in the same direction. Thus, the refractive index distribution is symmetrically formed with respect to the center of the beam. Moreover, the refractive index of the thermal lens 21 is maximized at the center of the beam and decreases toward to the edge of the beam. The range of distribution is smaller than the cross-sectional region of the beam of the fundamental waves 2. Since the low refractive index region 4 is distributed so as to offset the thermal lens 21, the thermal lens effect can be effectively suppressed. It is therefore desirable that the cross section of the low refractive index region 4 be located in a smaller region than the cross section of the beam of the fundamental waves 2 and the refractive index distribution be symmetrical with respect to the center of the beam of the fundamental waves 2. Furthermore, in the refractive index distribution, it is desirable that the refractive index be minimized at the center of the beam and increased up to around the refractive index of the substrate toward the edge of the beam.

The thermal lens effect can be offset by a refractive index difference Δn between the low refractive index region 4 and a peripheral region. The value of Δn needs to be set so as to minimize the influence of the wavelength conversion element 1 on conversion efficiency. The region of the thermal lens 21, that is, the distribution of the thermal lens 21 varies depending upon the output of harmonic waves, the phase matching temperature, and so on. Thus, the low refractive index region 4 needs to be extended as large as possible. In the case where the value of Δn exceeds a refractive index variation caused by light absorption, the conversion efficiency of the wavelength conversion element 1 is reduced. FIG. 4 illustrates the relationship between the refractive index differences Δn of the low refractive index region 4 and the other regions and the conversion efficiency of the wavelength conversion element 1. In the case where Δn is not larger than 1.0×10⁻⁵, a reduction in conversion efficiency is extremely small. In the case where Δn exceeds 1.0×10⁻⁴, the conversion efficiency is reduced by at least 50%. For this reason, it is preferable that Δn of the low refractive index region 4 is not larger than 1.0×10⁻⁴. More preferably, Δn is not larger than 1.0×10⁻⁵. Note that a refractive index variation on the thermal lens is about 1.0×10⁻⁵ and thus Δn smaller than 1.0×10⁻⁶ precludes the offset of the thermal lens effect. Hence, Δn desirably ranges from 1.0×10⁻⁶ to 1.0×10⁻⁴.

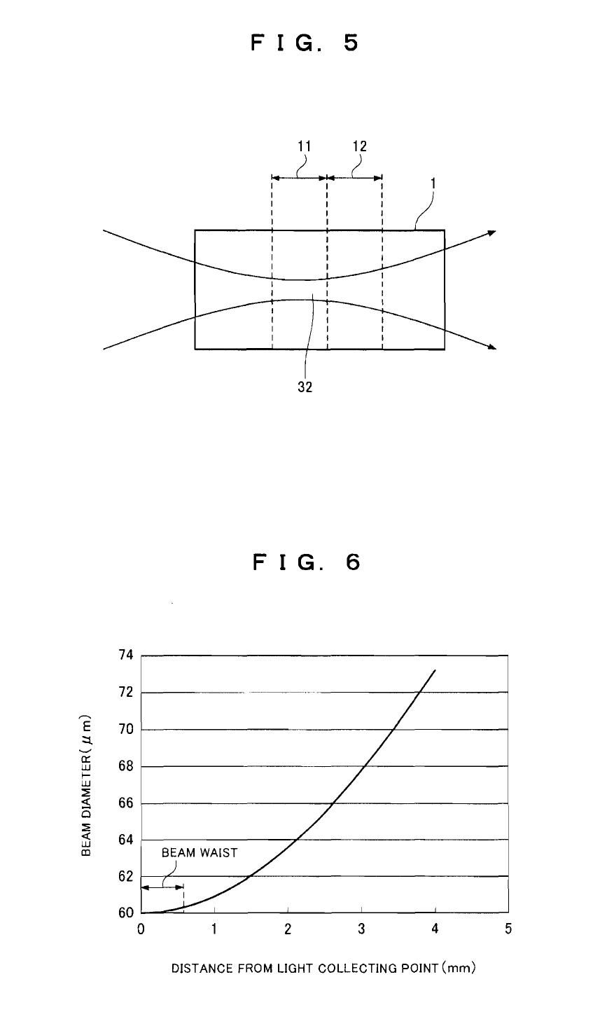

As shown in FIG. 1, the low refractive index region 4 is formed between the light collecting position of the fundamental waves 2 and the light outputting side of the wavelength conversion element 1, thereby achieving a desired effect. This is because as shown in FIG. 2, the thermal lens 21 forming the unstable region 22 in FIG. 3 is located between the light collecting position of the fundamental waves 2 and the light outputting side. FIG. 5 illustrates the positional relationship among a location 12 of the low refractive index region, a beam waist 11, and a light collecting point 32. In the case where the low refractive index region 4 of FIG. 1 is formed between the position of the beam waist 11 and the light inputting side, the occurrence of the thermal lens 21 cannot be suppressed, though the light collecting point 32 is shifted to the light outputting side. Moreover, in the case where the low refractive index region 4 is formed at the position of the beam waist 11, the light collecting characteristics of the beam are not affected, so that the occurrence of the thermal lens 21 is not suppressed. As has been discussed, the thermal lens 21 that collects a propagating beam appears between the light collecting point 32 of the beam of the fundamental waves 2 and the light outputting side. The beam waist 11 is defined as a region in which the beam of the fundamental waves 2 is not substantially diverged.

FIG. 6 illustrates an example of the relationship between a distance from the light collecting point 32 of FIG. 5 and a beam diameter. FIG. 6 shows the collection results of the fundamental waves 2 having a wavelength of 1064 nm with a light collecting diameter of 60 μm, by means of LiNbO₃ crystals doped with Mg. In the crystals, the beam diameter hardly varies in a region of about ±0.5 mm from the light collecting point 32. In this case, the beam waist 11 is located in the region of ±0.5 mm from the light collecting point 32 with few variations in beam diameter. The size of the beam waist 11 increases substantially proportionately with the size of a light collecting spot.

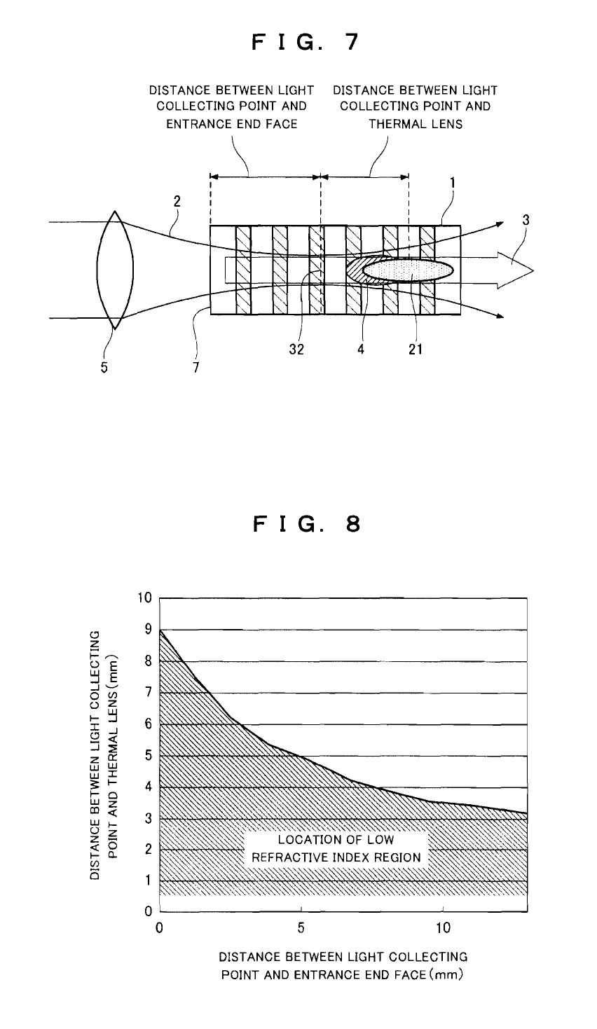

Referring to FIG. 7, the location 12 of the low refractive index region of FIG. 5 will be described below. In order to obtain the effect of suppressing the refractive power of the thermal lens 21 by the low refractive index region 4, an opposite refractive power against the refractive power of the thermal lens 21 is necessary. Since the thermal lens 21 is caused by light absorption, the effect of reducing the power density of light around the center of the thermal lens 21 is also important.

These two effects are effectively obtained by, as shown in FIG. 7, forming the low refractive index region 4 between the end of the beam waist 11 that is formed in a predetermined range from the light collecting point 32 in FIG. 5 to the center of the thermal lens 21. This is because the low refractive index region 4 formed closer to the beam waist 11 than the thermal lens 21 leads to a reduction in optical power density at the location of the thermal lens 21.

FIG. 8 shows calculation results on the relationship between a distance between the light collecting point 32 and an entrance end face 7 shown in FIG. 7 and a distance between the light collecting point 32 and the center position of the thermal lens 21 in the wavelength conversion element 1. The horizontal axis represents the former distance and the vertical axis represents the latter distance. The location of the thermal lens 21 is calculated based on the absorption coefficients of the fundamental waves 2 and the harmonic waves 3 on a MgO:LiNbO₃ substrate and the position of a point where a temperature increase by absorption at the light collecting spot is maximized. According to the results, as the light collecting point 32 comes closer to the entrance end face 7, a distance between the thermal lens 21 and the light collecting point 32 increases. The location 12 of the low refractive index region preferably corresponds to a hatched region in FIG. 8.

In order to use the nonlinear optical effect based on crystal anisotropy, the wavelength conversion element 1 having the periodic polarization inversion structure is made of birefringence materials that vary in crystal structure depending upon the crystal axis. In the use of the polarization inversion structure, the fundamental waves 2 polarized in C-axis direction having the largest nonlinear constant are converted into the harmonic waves 3 in the same direction. Thus, for a refractive index variation of the low refractive index region 4 (the suppression of the thermal lens effects of the fundamental waves 2 and the harmonic waves 3), Δn needs to be reduced with respect to the polarization in the C-axis direction. Specifically, the wavelength conversion element 1 preferably propagates the fundamental waves 2 substantially perpendicularly to the C axis of a nonlinear optical crystal and the low refractive index region 4 is preferably configured such that a reduction in refractive index in the C-axis direction of the nonlinear optical crystal is larger than that in a direction perpendicular to the C axis.

The low refractive index region 4 is preferably formed near the central axis of the beam in the propagation region of the beam of the fundamental waves 2. When deviated from the central axis of the beam, the low refractive index region 4 is likely to deteriorate the quality of the emitted beam and reduce the effect of suppressing the occurrence of the thermal lens 21. Since the beam diameter is several tens μm, the low refractive index region 4 is preferably formed with the accuracy of several μm with respect to the central axis of the beam.

The low refractive index region 4 is formed with a cross section that substantially matches the cross section of the beam of the fundamental waves 2 (an area having a maximum power of 1/e²) or the low refractive index region 4 is not larger than the cross-sectional area of the beam of the fundamental waves 2, thereby most effectively suppressing the occurrence of the thermal lens 21. This is because the thermal lens 21 is formed according to the beam intensity distributions of the fundamental waves 2 and the harmonic waves 3 and thus the low refractive index region 4 is formed in the same region as the thermal lens 21 to effectively offset the thermal lens 21.

In this case, the light collecting point 32, which is the position of the collected beam of the fundamental waves 2, is located in the wavelength conversion element 1. In the case where the light collecting point 32 is located on the entrance end face 7 of the wavelength conversion element 1, resistance to high output can be further improved. The light collecting point 32 disposed on the entrance end face 7 of the wavelength conversion element 1 reduces the power densities of the fundamental waves 2 and the harmonic waves 3 in the wavelength conversion element 1 and increases a distance between the thermal lens 21 and the light collecting point 32. Hence, the power density considerably decreases at the center of the thermal lens 21, achieving higher resistance to high output.

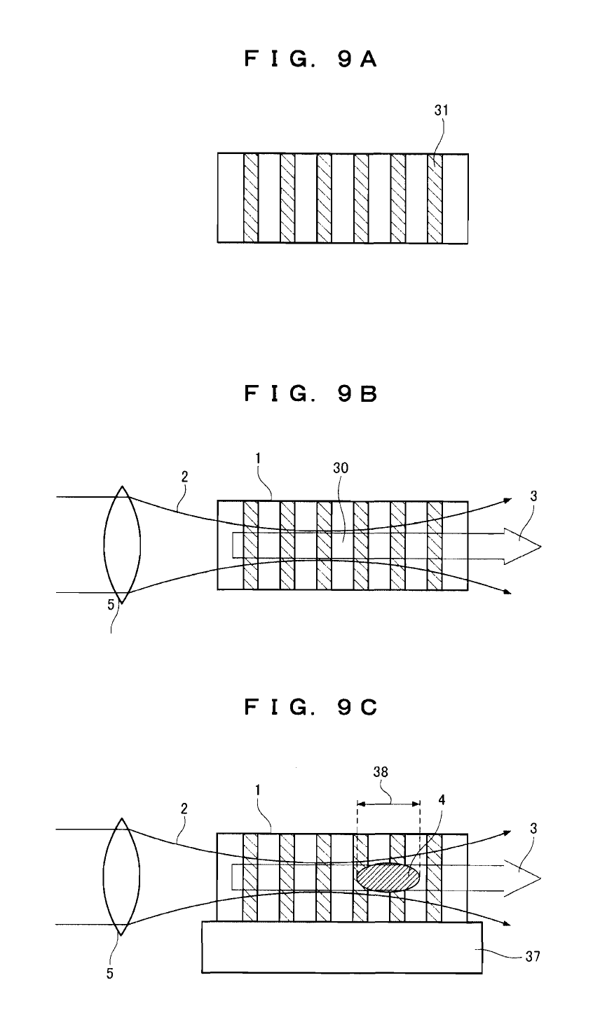

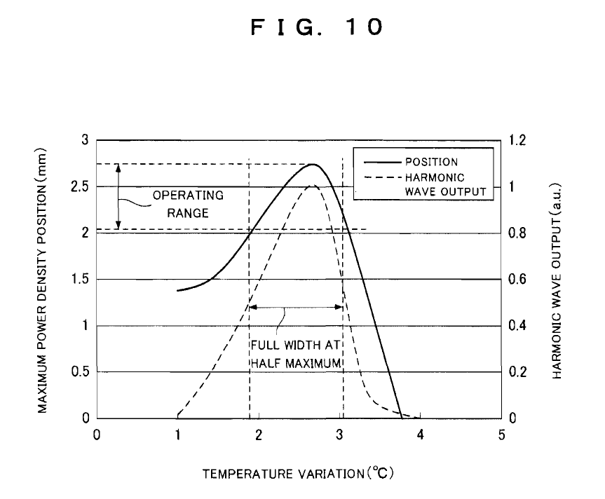

Referring to FIGS. 9A to 9C, a method for manufacturing the wavelength conversion element of the present invention will be described below.

In order to improve the high-output resistance of the wavelength conversion element 1, the low refractive index region 4 needs to be accurately formed in the propagation region of the beam of the fundamental waves 2. The beam has a radius of several tens μm and a refractive index difference is 10⁻⁴ or less. Thus, it is difficult to accurately form the low refractive index region 4 in a crystal. A feature of the wavelength conversion element 1 according to the present invention is the low refractive index region 4 formed by two-photon absorption characteristics.

It is known that a refractive index is varied by two-photon absorption when ferroelectric materials doped with metals such as Mg are irradiated with light. The materials include congruent and stoichiometric materials of LiNb0₃ and LiTaO₃ or KTiOPO₄. In a method of moving electrons by two photon energies to a level having a wide band gap, a refractive index distribution can be stably stored by, for example, hologram elements using two-photon absorption. In the present invention, the low refractive index region 4 is formed by two-photon absorption using two photons of the fundamental waves 2 and harmonic waves 3.

First, as shown in FIG. 9A, an electric field is applied to nonlinear optical crystals from the outside to form a periodic polarization inversion structure 31. After that, as shown in FIG. 9B, the fundamental waves 2 are collected in the wavelength conversion element 1 having the polarization inversion structure 31 by means of the light collecting optical system 5. The wavelength conversion element 1 includes a light collecting position 30. The temperature of the wavelength conversion element 1 is set at a phase matching temperature at which the refractive index of the fundamental waves 2 is equal to that of the harmonic waves 3, so that the harmonic waves 3 can be efficiently emitted. The harmonic waves 3 gradually increase from the light inputting side to the light outputting side of the wavelength conversion element 1, so that the power density of the harmonic waves 3 is maximized between the light collecting position 30 of the fundamental waves 2 and the light outputting side. The position of the low refractive index region 4 formed using two-photon absorption depends upon the power density of the harmonic waves 3 and is located mainly around a point where the power density of the harmonic waves 3 is maximized.

Unfortunately, the low refractive index region 4 formed in this state is less effective because of its small volume and insufficient length in the propagation direction of light. Thus, as a method of enhancing the effect of offsetting the thermal lens 21, the volume of the low refractive index region 4 needs to be increased. FIG. 9C illustrates, as a technique for this purpose, a method of increasing a length 38 of the low refractive index region 4.

As shown in FIG. 9C, a Peltier element 37 for controlling the temperature of the wavelength conversion element 1 is assembled and fixed in addition to a fundamental wave light source (not shown) for generating the fundamental waves 2, the light collecting optical system 5, and the wavelength conversion element 1, so that a light source module is completed. The completion of the light source module fixes the relationship between the wavelength conversion element 1 and the beam position of the fundamental waves 2. After that, the low refractive index region 4 is formed in the propagation region of the beam of the fundamental waves 2, which eliminates the need for aligning the beam of the fundamental waves 2 and the beam of the harmonic waves 3. Furthermore, the low refractive index region 4 can be accurately formed at the center of the beam of the fundamental waves 2 by using two-photon absorption. The temperature of the wavelength conversion element 1 is changed in this state, so the volume of the low refractive index region 4 can be increased.

Specifically, when the fundamental waves 2 are partially converted into the harmonic waves 3 in the wavelength conversion element 1, a region simultaneously including the fundamental waves 2 and the harmonic waves 3 is formed. In this region, two-photon absorption by light of two wavelengths occurs, which forms the low refractive index region 4. However, the volume of the low refractive index region 4, that is, the length 38 is not sufficiently obtained simply by generating the harmonic waves 3 in the wavelength conversion element 1. Thus, the temperature of the wavelength conversion element 1 is changed around the phase matching temperature by using the Peltier element 37. A temperature change of the wavelength conversion element 1 leads to a change of the intensity distribution of the harmonic waves 3 in the wavelength conversion element 1. By using this phenomenon, a position where the power density of the harmonic waves 3 is maximized can be moved in the longitudinal direction of the wavelength conversion element 1. In other words, the fundamental waves 2 are converted into the harmonic waves 3 in the wavelength conversion element 1 and the temperature of the wavelength conversion element 1 is changed around the phase matching temperature at which the harmonic waves 3 are generated, so that the low refractive index region 4 can be formed over a wide range.

FIG. 10 shows calculation results on the relationship between a change of harmonic wave output and a position where the power density of the harmonic waves 3 is maximized in the wavelength conversion element 1, in the case where the temperature of the wavelength conversion element 1 is changed from the phase matching temperature. For the wavelength conversion element 1, a physical constant of LiNbO₃ doped with Mg of 5 mol was used. A maximum power density position is represented as a distance in millimeters from the light collecting position 30 of the fundamental waves 2 to the light outputting side. In this case, the total length of the wavelength conversion element 1 is 26 mm and the light collecting position 30 of the fundamental waves 2 is located at the center, that is, 13 mm from the end of the wavelength conversion element 1. The temperature dependence of harmonic wave output is left-right asymmetric because of a temperature distribution caused by the absorption of the fundamental waves 2 and the harmonic waves 3. This result matches another experimental result. As shown in FIG. 10, a full width at half maximum is about 1.2° C. when the harmonic wave output is halved. At this point, the maximum position of the power density of the harmonic waves 3 can be changed in the range from 2.1 mm to 2.8 mm, that is within a 0.7-mm range, from the light collecting position 30 of the fundamental waves 2. In other words, the length 38 of the low refractive index region 4 can be formed in the range of at least 0.7 mm. Furthermore, in the case where the temperature of the wavelength conversion element 1 is changed to the full width, the maximum position of the power density of the harmonic waves 3 can be moved by 2.8 mm. However, the change of the temperature of the wavelength conversion element 1 to the full width or more leads to a large reduction in the output of the harmonic waves, so that Δn of the low refractive index region 4 decreases. For this reason, even in the case where the temperature is changed to the full width or more, the low refractive index region 4 is not increased and the effect of suppressing the thermal lens 21 is unchanged. According to an experiment, the temperature of the wavelength conversion element 1 is changed at least by the full width at half maximum of the phase matching temperature, so that the effect of suppressing the thermal lens is greatly enhanced to improve the high output characteristics from 2.5 W to 3 W.

As can be seen in FIG. 10, at a temperature where the harmonic wave output is maximized, the position of the maximum power density is located farthest from the light collecting position 30. Thus, the range of temperature variations is preferably at least one of the range from the phase matching temperature to the full width at half maximum with the maximum harmonic wave output on the high temperature side and the range from the phase matching temperature to the full width at half maximum on the low temperature side.

The relationship with the phase matching temperature will be discussed below. In a refractive index changing method using two-photon absorption, electrons are moved at a trap level to obtain a change of a refractive index. Thus, a temperature rise leads to an active movement of the electrons and then the electrons are released from the trap level, reducing Δn of the low refractive index region 4. For this reason, it is difficult to form the low refractive index region 4 at a high temperature. In LiNbO₃ and LiTaO₃ that contain Mg, In, Zn, Sc and the like or LiNbO₃ and LiTaO₃ of stoichiometry, a threshold value is set at about 100° C. Hence, in the case where the temperature of the wavelength conversion element 1 is raised to 100° C. or higher, Δn of the low refractive index region 4 increases, considerably reducing the effect of suppressing the thermal lens 21. The same effect is obtained also in the forming process of the low refractive index region 4. Therefore, the phase matching temperature of the wavelength conversion element 1 needs to be set at 100° C. or lower.

In the formation of the low refractive index region 4 by light irradiation, that is, the formation of the refractive index distribution, electrons (holes) at a deep level are ionized by two-photon absorption and then are recombined while passing through a conduction band. As a result, a charge distribution appears in crystals, an internal electric field is generated, and then a refractive index is changed by an electro-optical effect. A relatively stable electric field distribution can be formed because of the deep energy level. Charge moves in the spontaneous polarization direction of crystals, so that the electric field distribution is formed in the C-axis direction of crystals and a refractive index distribution for polarization in the C-axis direction is formed by the electro-optical effect. In other words, with respect to a beam propagating perpendicularly to the C-axis of crystals, a refractive index in beam cross-section considerably decreases in the C-axis direction.

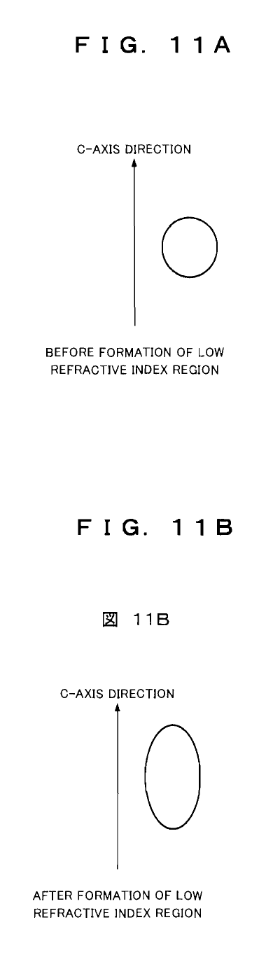

As a result, the outgoing beam is changed from a circular beam that does not include the low refractive index region 4 in FIG. 11A to an oval beam that includes the low refractive index region 4 with the long axis disposed along the C-axis direction in FIG. 11B. In other words, a feature of the wavelength conversion element 1 of the present invention is that a circular incoming beam changes to an oval outgoing beam. The oval beam causes an aberration in the collection of the beam by the thermal lens effect, thereby reducing the power density of the light collecting spot formed by the thermal lens 21. Hence, the occurrence of the unstable region 22 with a high output can be reduced.

The formation of the low refractive index region 4 leads to a reduction in the phase matching temperature of the wavelength conversion element 1. In a measurement of the refractive index of the formed low refractive index region 4, a reduction in phase matching temperature was about 0.2° C. to 0.4° C. A temperature variation in the crystals of the wavelength conversion element 1 was determined from this value and was converted into a refractive index variation. As a result, the refractive index difference Δn between the low refractive index region 4 and the other parts was about 1×10⁻⁵ to 4×10⁻⁵. This value proves that a refractive index variation satisfying the characteristics of FIG. 4 is obtained.

The stability of the low refractive index region 4 will be described below. The low refractive index region 4 is generated by the distribution of ions. An increase in crystal temperature accelerates ion generation, so that the charge distribution disappears. Thus, an increase in crystal temperature leads to the disappearance of the low refractive index region 4. According to an experiment, a refractive index variation of the low refractive index region 4 decreased at a crystal temperature of about 100° C. and the low refractive index region 4 disappeared at 120° C. Therefore, after the low refractive index region 4 is formed, the temperature of the wavelength conversion element 1 according to the present invention is preferably kept below 100° C. Furthermore, irradiation of light such as ultraviolet with high photon energy also changes the distribution of the low refractive index region 4. Thus, ultraviolet light is preferably blocked after the formation of the low refractive index region 4. Hence, the phase matching temperature is preferably set at 100° C. or less.

The low refractive index region 4 is formed by two-photon absorption along the intensity distributions of the fundamental waves 2 and the harmonic waves 3, so that the low refractive index region 4 is formed so as to approximate the product of the electric field distributions. Thus, an intensity distribution substantially identical to the cross section of the propagating beam can be formed, which can efficiently offset the thermal lens effect.

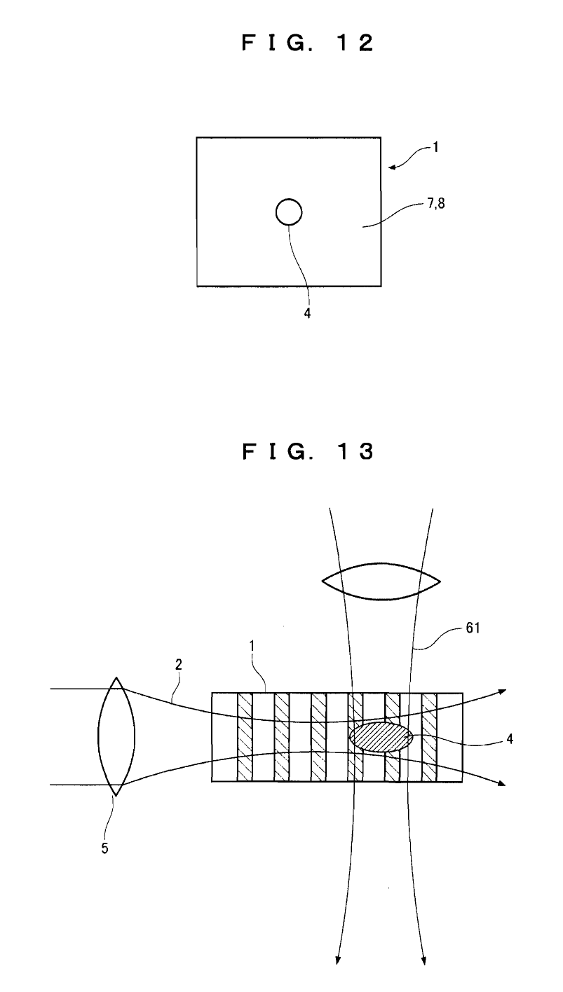

The formation of the low refractive index region 4 can be analyzed by several methods. As has been discussed, the formation of the low refractive index region 4 can be confirmed by the ovalization of an outgoing beam. Moreover, as shown in FIG. 12, the formation of the low refractive index region 4 can be confirmed by an observation from the entrance end face 7 or an exit end face 8 of the wavelength conversion element 1. The ellipticity of the beam is several % to about 10%. In other words, parallel light is transmitted through the wavelength conversion element 1 by, for example, a wave surface measuring device and an interference microscope, and then as shown in FIG. 12, the wavelength conversion element 1 is observed from the entrance end face 7 and the exit end face 8 of the wavelength conversion element 1, so that the low refractive index region 4 can be observed in the crystals of the wavelength conversion element 1. Although the low refractive index region 4 has a small refractive index variation, the length 38 of the low refractive index region 4 is long and thus the refractive index variation is integrated, enabling an observation from the entrance end face 7 and the exit end face 8.

The same effect can be obtained for pulsed light as well as continuous light.

As the wavelength conversion element 1, an optical element having the polarization inversion structure described above is effectively used. Particularly effective optical elements including LiNbO₃ doped with Mg (congruent composition/stoichiometry composition), LiTaO₃ doped with Mg (congruent composition/stoichiometry composition), and KTiOPO₄. A refractive index variation caused by two-photon absorption can be increased by adding metals such as Mg, In, Zn, and Sc. Moreover, the addition of these metals improves the stability of the refractive index variation. For this reason, LiNbO₃, LiTaO₃, and KTiOPO₄ that contain these metals are effectively used.

In this explanation, a wavelength conversion element using the nonlinear optical effect was described as an example of the wavelength conversion element 1. The wavelength conversion element 1 may be an optical element having the polarization inversion structure in which the phase of light is matched using the period of the polarization inversion structure, or an optical element for matching the speeds of light and microwaves or the like.

Moreover, in this explanation, conversion from infrared light (1064 nm) to visible light (532 nm) was described as an example of wavelength conversion. The present invention is also applicable to, for example, sum frequency generation, difference frequency generation, and parametric oscillation as well as the generation of second harmonic waves as long as the phase of light is matched using the period of the polarization inversion structure.

The collection of the fundamental waves 2 around the center of the wavelength conversion element 1 was described as an example of a method for manufacturing the wavelength conversion element 1. The fundamental waves 2 may be collected around the light inputting part of the wavelength conversion element 1. In this case, the high output resistance can be further improved. In the case where the temperature of the wavelength conversion element 1 is changed to form the low refractive index region 4 by two-photon absorption, the light collecting point 32 located near the light inputting part forms the low refractive index region 4 at a point separated from the light collecting point 32 to an exit side by about 2 mm; meanwhile, as shown in FIG. 8, the position of the formed thermal lens 21 is separated from the light collecting position 30 by about 9 mm. Thus, the concave lens effect of the low refractive index region 4 enhances the effect of reducing the power density of the fundamental waves 2 in the thermal lens 21, thereby greatly improving the high output resistance.

As another method of increasing the length 38 of the low refractive index region 4, the wavelength conversion element 1 may be moved with respect to the light collecting position 30 of the beam of the fundamental waves 2.

FIG. 13 shows another method of forming the low refractive index region 4 over a wide range. In the method of FIG. 13, the low refractive index region 4 is formed by emitting two beams crossing each other with different wavelengths. In other words, the fundamental waves 2 (1064 nm) incident on the wavelength conversion element 1 are collected in the wavelength conversion element 1 by the light collecting optical system 5. In response to the fundamental waves 2, irradiation light 61 having a wavelength from 320 nm to 600 nm is emitted from the side of the wavelength conversion element 1 to the propagation region of the fundamental waves 2 in the wavelength conversion element 1. Thus, a refractive index can be changed by two-photon absorption. The low refractive index region 4 is formed by using the refractive index variation.

The irradiation light 61 requires a power of about 1 W for light of nearly 500 nm and a power of several hundreds mW for light of nearly 400 nm, depending upon the wavelength. The fundamental waves 2 emitted at the same time are set at several W, achieving a refractive index variation. A stable refractive index variation is obtained by two-photon absorption, so that a refractive index variation is small even after the wavelength conversion element 1 is operated for an extended period of time.

As has been discussed, the irradiation light 61 preferably has a wavelength from 320 nm to 600 nm when the fundamental waves 2 have a wavelength of 1064 nm. In the case where the irradiation light 61 has a wavelength of 320 nm or less, the irradiation light 61 is absorbed on the surface of the substrate and does not reach the beam of the fundamental waves 2 because of the low transmittance of the substrate. Thus, a two-photon absorption effect cannot be obtained. In the case where the irradiation light 61 has a wavelength of at least 600 nm, the sum of the photon energies of the fundamental waves 2 and the irradiation light 61 decreases, precluding the acquisition of the two-photon absorption effect.

Methods of forming the low refractive index region 4 with an extended length include a method of moving the irradiation position of the irradiation light 61 along the longitudinal direction of the wavelength conversion element 1 and a method of crossing the fundamental waves 2 and the irradiation light 61 shaped like a linear beam.

In the case where the low refractive index region 4 is formed in this manner, nonlinear optical crystals having polarization inversion structures are effectively used as the wavelength conversion element 1. Particularly, for example, Mg:LiNbO₃ (congruent composition/stoichiometry composition), Mg:LiTaO₃ (congruent composition/stoichiometry composition), and KTiOpO₄ are effectively used.

In this explanation, conversion from infrared light (1064 nm) to visible light (532 nm) was described as an example of wavelength conversion. The present invention is also applicable to, for example, sum frequency generation, difference frequency generation, and parametric oscillation as well as the generation of second harmonic waves as long as the phase of light is matched using the period of the polarization inversion structure.

According to the wavelength conversion element 1 of the present invention, the provision of the low refractive index region 4 in the optical path of the fundamental waves 2 can reduce the lens power of the thermal lens 21 generated by light absorption. Thus, even if light of the harmonic waves 3 is generated with a high power, a stable output can be obtained. Furthermore, unlike in a known technique, the present invention does not require a known drive part that changes the beam position of the fundamental waves 2 to avoid an unstable output when a high power is outputted. Hence, a short-wave generating apparatus according to the present invention has a simple configuration that can be easily manufactured. Moreover, the fixed beam position leads to stable light collecting characteristics in the collection of the beam.

According to the wavelength conversion element 1 of the present invention, the nonlinear optical crystals are crystals that absorb at least one of the fundamental waves 2 and the harmonic waves 3 or absorb the waves by the interaction of the fundamental waves 2 and the harmonic waves 3. Thus, the thermal lens 21 can be generated when harmonic waves are generated with a high output. The generation of the thermal lens 21 suppresses the divergence of the beam of the fundamental waves 2, thereby improving the power density of light and conversion efficiency. At this point, a high-refractive index part forming the thermal lens 21 is offset by the low refractive index region 4 of the present invention, so that a stable output can be obtained with a high output.

According to the present invention, the low refractive index region 4 has a large refractive index variation in response to an extraordinary ray, thereby transforming a propagating beam into a flat beam. Thus, the influence of the thermal lens 21 can be reduced and the resistance can be improved with a high output.

In the present invention, the phase matching temperature and the storage temperature of the wavelength conversion element 1 are preferably kept below 100° C. According to examination results obtained by the present inventors, it is difficult to stably keep the refractive index of the low refractive index region 4 at 100° C. or higher. Hence, the low refractive index region 4 can be stably maintained at 100° C. or lower.

In the wavelength conversion element 1 of the present invention, the nonlinear optical crystals are preferably LiNbO₃ and LiTaO₃ that contain Sc of at least 2 mol or Mg, Zn, and In of at least 5 mol with a congruent composition or LiNbO₃ and LiTaO₃ that contain Sc of at least 0.5 mol or Mg, Zn, and In of at least 1 mol with a fixed ratio composition (stoichiometry composition). These wavelength conversion elements have excellent resistance to optical damage, achieving high-output characteristics. Moreover, the high resistance to optical damage enables the generation of visible light around room temperature.

The nonlinear optical crystals of the wavelength conversion element 1 according to the present invention are preferably LiNbO₃ and LiTaO₃ that contain Mg of at least 5.5 mol with a congruent composition or LiNbO₃ and LiTaO₃ that contain Mg of about 1 mol with a fixed ratio composition (stoichiometry composition). The larger the content of metal additives, the higher the resistance to a high output.

### INDUSTRIAL APPLICABILITY

According to a wavelength conversion element of the present invention, even if a harmonic beam is continuously generated for an extended period of time, a stable output can be obtained without being reduced. The wavelength conversion element having excellent high-output characteristics is provided, thereby achieving a short-wavelength light generating apparatus suitable for commercial use such as displays with a more reliable laser module.

1. A wavelength conversion element for converting fundamental waves into harmonic waves having shorter wavelengths than wavelengths of the fundamental waves,
wherein the wavelength conversion element includes a low refractive index region having a lower refractive index than refractive indexes of other regions.

2. The wavelength conversion element according to claim 1, wherein the low refractive index region is formed in a forming region of a thermal lens in the wavelength conversion element.

3. The wavelength conversion element according to claim 1, wherein a refractive index difference between the low refractive index region and the other regions ranges from 1.0×10⁻⁶ to 1.0×10⁻⁴.

4. The wavelength conversion element according to claim 1, wherein the low refractive index region is formed between a light collecting position of the fundamental waves and a light outputting side in the wavelength conversion element.

5. The wavelength conversion element according to claim 1, wherein the low refractive index region is formed between an end of a beam waist and a center of a forming region of a thermal lens in the wavelength conversion element, the beam waist being formed in a predetermined range from a light collecting position of the fundamental waves.

6. The wavelength conversion element according to claim 1, wherein the low refractive index region is formed in a region where a symmetric with respect to a center of a beam of the fundamental waves and as large as or smaller than a cross-sectional region in which the fundamental waves have an intensity of 1/e².

7. The wavelength conversion element according to claim 1, wherein the wavelength conversion element is made of a nonlinear optical crystal that is varied in refractive index by two-photon absorption using two different wavelengths.

8. The wavelength conversion element according to claim 7, wherein the wavelength conversion element is configured such that the fundamental waves propagate in a direction substantially perpendicular to C axis of the nonlinear optical crystal, and
the low refractive index region has a refractive index difference from the other regions such that a refractive index difference along the C axis of the nonlinear optical crystal is larger than a refractive index difference in a direction perpendicular to the C axis.

9. The wavelength conversion element according to claim 1, wherein a nonlinear optical crystal is one of LiNbO₃ or LiTaO₃ doped with Mg with a congruent composition, LiNbO₃ or LiTaO₃ doped with Mg with a stoichiometry composition, and KTiOPO₄.

10. The wavelength conversion element according to claim 1, wherein the wavelength conversion element includes one of a thermal lens formed by absorbing one of the fundamental waves and the harmonic waves and a thermal lens formed by absorption based on an interaction between the fundamental waves and the harmonic waves.

11. The wavelength conversion element according to claim 1, wherein the wavelength conversion element has a phase matching temperature of 100° C. or less.

12. An apparatus for generating short-wavelength light, comprising:
a fundamental wave light source;
the wavelength conversion element according to claim 1; and
a light collecting optical system that collects fundamental waves.

13. The apparatus for generating short-wavelength light according to claim 12, wherein a light collecting position is set such that a distance from the light collecting position of the fundamental waves to an entrance surface in the wavelength conversion element is smaller than a distance from the light collecting position to an exit surface.

14. The apparatus for generating short-wavelength light according to claim 12, wherein the fundamental wave has a wavelength of 680 nm to 1200 nm:

15. The apparatus for generating short-wavelength light according to claim 12, wherein a fundamental beam circular in cross section is incident on the wavelength conversion element, and then a beam oval-like in cross section is emitted from the wavelength conversion element.
